(19) United States
(12) Patent Application Publication
(10) Pub. No.: US 2008/0126125 A1
(43) Pub. Date: May 29, 2008

(54) Remote Health Care

(75) Inventors: Jay Lichtenstein, Robbinsville, NJ (US); Franklyn Laifer, New York, NY (US)

Correspondence Address: FISH & RICHARDSON PC, P.O. BOX 1022, MINNEAPOLIS, MN, 55440-1022, US

(73) Assignee: HeartWatch, LLC

(21) Appl. No.: 11/832,407

(22) Filed: Aug. 1, 2007

Related U.S. Application Data
(60) Provisional application No. 60/835,123, filed on Aug. 1, 2006.

(51) Int. Cl. G06Q 10/00

(52) U.S. Cl. 705/2

(57) ABSTRACT

Among other things, a remote health care system includes a diagnostic receiver, a medical records module in data communication with the diagnostic receiver, and an emergency services module in data communication with the diagnostic receiver. The diagnostic receiver is configured to receive a diagnostic test from a patient, the medical records module includes a medical record of the patient, and the emergency services module includes a description of a geographic location and an emergency vehicle dispatch center corresponding to the location.

### RELATED APPLICATION INFORMATION

This application claims priority to U.S. provisional application Ser. No. 60/835,123, filed Aug. 1, 2006.

### BACKGROUND

Heart attacks and other adverse cardiac events are responsible for a relatively large proportion of health care expenses and death in the United States. After a person experiences an adverse cardiac event, the timeliness of the treatment the person receives is a significant factor in the person's chances for survival or recovery. For example, when the adverse cardiac event is a heart attack, some medical guidelines call for treatment within the one to two hours in order to dramatically increase the person's chances of survival. Without treatment for two hours after the heart attack occurs, the person typically can experience irreversible damage, and the fatality rate doubles.

Often, a person who has an adverse cardiac event does not immediately recognize it as such. For example, the person may interpret the symptoms of the cardiac event as indigestion or common aches or pains. Additionally, some people who experience a cardiac event do not seek immediate treatment because of the expense (in either money or time) of a trip to the emergency room, which they may regard as “wasted” if in fact no adverse cardiac event occurred. Even still, “false alarm” trips to emergency rooms actually do occur among heart patients. These false alarms tend to reinforce the tendency to not seek care at the first sign of symptoms. These and other real or imagined obstacles to immediate diagnosis and treatment contribute to the high health care expenses and the high death rates from adverse cardiac events.

### SUMMARY

In general, in one aspect, a remote health care system includes: a diagnostic receiver configured to receive a diagnostic test from a patient; a medical records module in data communication with the diagnostic receiver, the medical records module including a medical record of the patient; and an emergency services module in data communication with the diagnostic receiver, the emergency services module including a description of a geographic location and an emergency vehicle dispatch center corresponding to the location.

Implementations may include one or more of the following features. The remote health care system also includes a fault detection module configured to: detect a malfunctioning component of the remote health care system and; activate a duplicate component of the health care system. The remote health care system also includes a communications module in data communication with the emergency services module, the communications module configured to cause the emergency vehicle dispatch center to dispatch an emergency vehicle to the patient. The remote health care system also includes a communications module in data communication with the medical records module, the communications module configured to transmit the medical record to a treatment facility. The remote health care system also includes a communications module in data communication with the medical records module, the communications module configured to transmit a cardiac evaluation of the patient to a personal physician of the patient. The diagnostic receiver includes an EKG module, and the diagnostic test includes an EKG test. The EKG module is configured to compare the EKG test to the medical record. In another aspect, a method includes: receiving a medical record for a patient; subsequently receiving a description of symptoms from the patient, the symptoms describing a current medical state of the patient; transmitting a description of the symptoms to a cardiologist; receiving a diagnostic test from the patient; and transmitting the results of the diagnostic test to the cardiologist.

Implementations may include one or more of the following features: The diagnostic test includes an EKG test. The diagnostic test includes a blood test. The medical record includes a description of a medical history including a description of at least one cardiac test result. The medical record includes a complete medical history of the patient. The method also includes transmitting a portion of the medical history to the cardiologist. The method also includes determining a location of the patient. The method also includes determining an emergency vehicle dispatch center based on the location of the patient. The method also includes causing the emergency vehicle dispatch center to dispatch an emergency vehicle to the location of the patient. The method also includes determining a probable course of treatment of the patient. The method also includes determining a treatment facility based on the probable course of treatment. The method also includes causing the emergency vehicle dispatch center to dispatch an emergency vehicle to the location of the patient and transport the patient to the treatment facility. The method also includes querying a personal physician of the patient for an updated medical record for the patient. The method also includes querying the patient for an updated diagnostic test. The diagnostic test includes an EKG test. The diagnostic test includes a blood test. The method also includes seeking reimbursement for a provided service. The reimbursement is sought from an insurer of the patient. The patient is located in a first country and one of the cardiologist or an operator is located in a second country. The patient is located in a first country and the cardiologist is located in a second country and the operator is in a third country. The method also includes receiving information about the medical condition of the patient from the cardiologist, and transmitting the information to a health care provider. The method also includes: recording an evaluation of the current medical state of the patient by the cardiologist; displaying the evaluation to a reviewing cardiologist; and receiving a quality review of the evaluation from the reviewing cardiologist.

In another aspect, a method of treating a patient for a cardiac disorder includes: receiving information about a patient from a remote source; in response to said information, scheduling a service for the patient.

Implementations may include one or more of the following features: The service includes administering medication to the patient. The medication includes a component selected from the group consisting of: tPA, uokinase, enoxaparin, and heparin. The service includes performing a surgical procedure. The surgical procedure is selected from the group consisting of: performing bypass surgery, performing an angioplasty, and installing a stent. The service is performed within 1, 2, 3 or 4 hours of receiving information from the remote source.

In another aspect, a method of dispatching an emergency vehicle to a patient includes: receiving instructions from a device or method described herein; dispatching an emergency vehicle to the patient.

In another aspect, a method of making a decision, selecting a payment class, or authorizing (or denying), transmitting or making a payment for a treatment, e.g., a medication, or a surgical intervention, or other product or service, for a subject having or suspected of having a cardiac disorder, the method includes, providing (e.g., receiving) information about said subject from a system or method described herein, and based on that information, making a decision, e.g., selecting a payment class, or authorizing, transmitting or making a payment.

In another aspect, a method of making a decision, selecting a payment class, or authorizing (or denying), transmitting or making a payment for a treatment, e.g., a medication, or a surgical intervention, or other product or service, for a subject having or suspected of having a cardiac disorder, the method including, providing (e.g., receiving) information about whether a decision with regard to said subject was made with a device or method described herein, and based on that determination, making a decision, e.g., selecting a payment class, or authorizing, transmitting or making a payment.

Implementations may include one or more of the following features. There is a first level of reimbursement is said device or method was used and a second level if it was not.

Some implementations may include one or more of the following advantages. A cardiologist reviewing a patient's symptoms, as opposed to a nurse or a person trained to adhere to a protocol, imports a high degree of cardiac training and experience to the review. As a result, the review may be of higher quality. By contacting the emergency vehicle dispatch center (e.g., a 9-1-1 call center) that is local to the patient, the emergency vehicle's response time is reduced. Moreover, the patient may remain in communication with the cardiologist, who can closely monitor the patient and provide up-to-date instructions to care givers when the patient arrives at a care facility.

Other aspects include other combinations of the features recited above and other features, expressed as methods, apparatus, systems, program products, and in other ways. Other features and advantages will be apparent from the description and from the claims.

### DETAILED DESCRIPTION

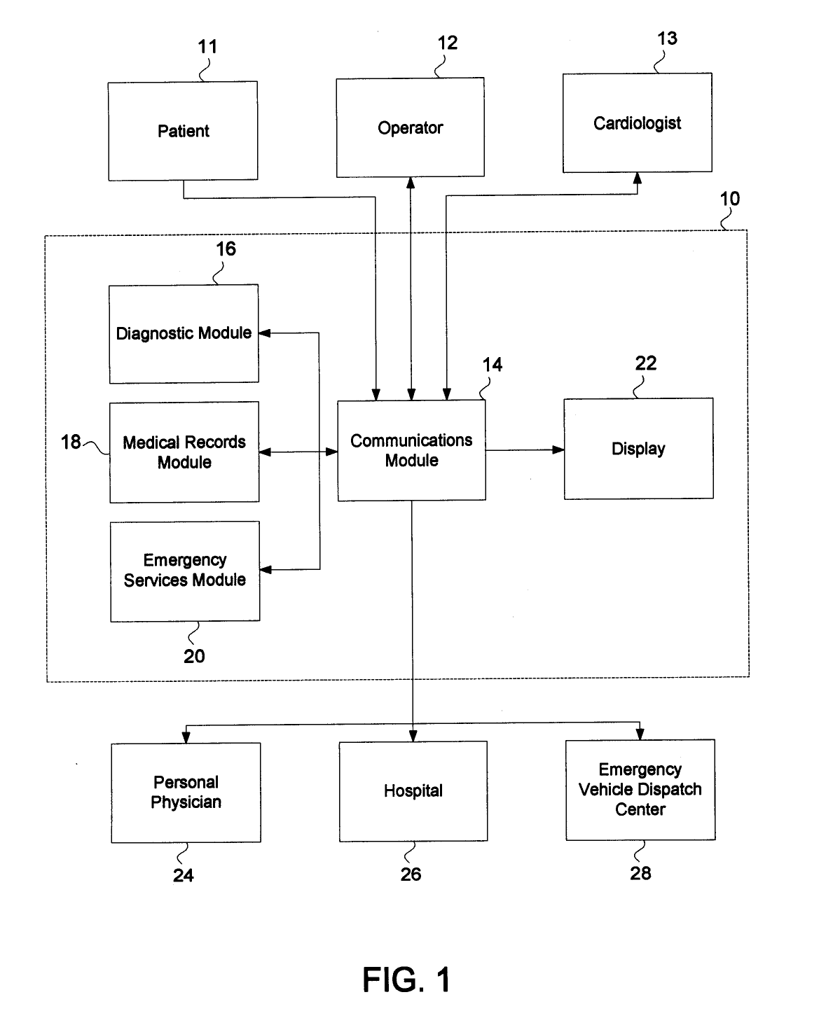

FIG. 1 is a schematic depiction of a remote health care system.

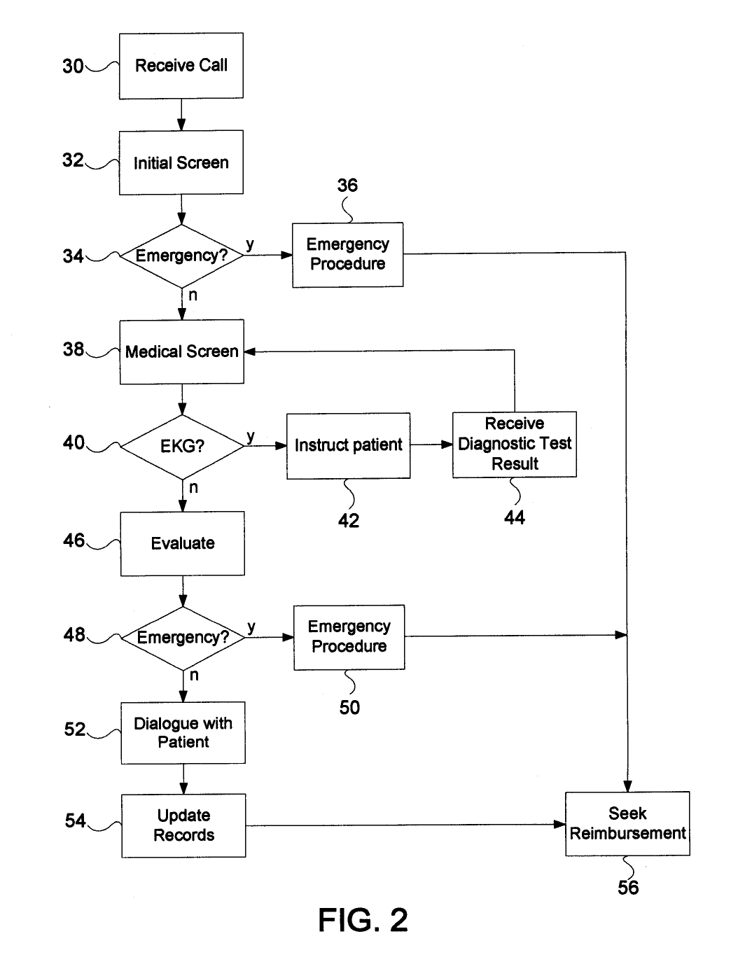

FIG. 2 is a flowchart illustrating a use of the remote health care system.

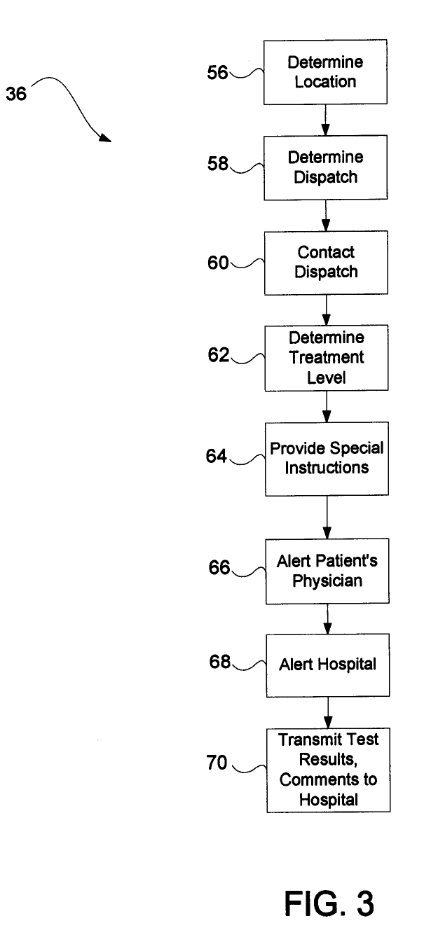

FIG. 3 is a flowchart illustrating an emergency procedure.

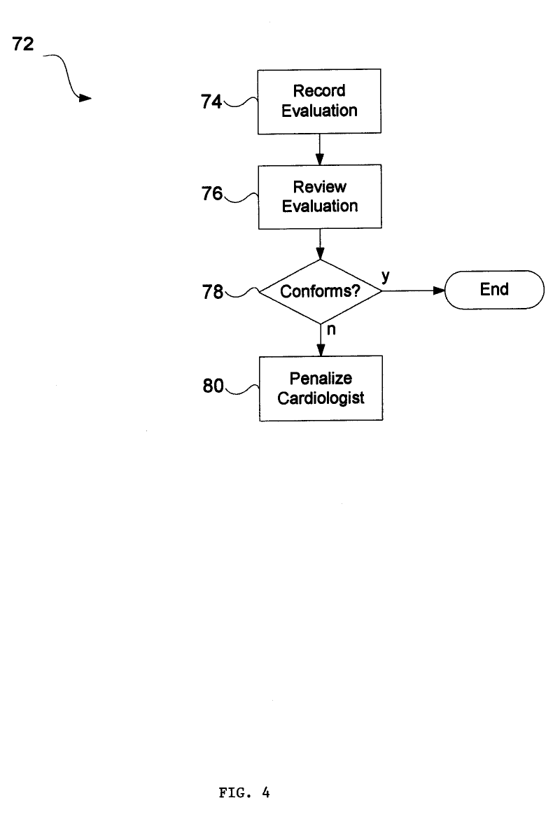

FIG. 4 is a flowchart illustrating a quality control procedure.

Referring to FIG. 1, a remote health care system 10 is used to evaluate a patient 11 who has recently experienced symptoms indicative of a potential cardiac event. The patient 11 establishes communication with the remote health care system 10. The mode of communication may include any known mode, for example voice communication, text-based communication, including encrypted or non-encrypted data transmissions, video communication, or other mode. The medium of communication may include any known medium, including a metallic or fiber-optic communication line, or modulated electromagnetic signals, such as those used by a cellular telephone or other wireless devices. In what follows, the communication between the patient 11 and the operator 12 is referred to as a “call.” Use of this term is not meant to limit the patient/operator communication to any particular medium or mode.

The remote health care system 10 initially routes the patient's call to an operator 12. The operator 12 includes a cardiologist 13, a cardiac care nurse, a paramedic trained in electrocardiograms (EKGs). Although only one operator 12 and cardiologist 13 are depicted in FIG. 1, in principle any number of operators 12 or cardiologists 13 may simultaneously use the remote health care system 10. Although an operator 12 and a cardiologist 13 are depicted separately in FIG. 1, the cardiologist 13 may serve as an operator 12.

In some implementations, the cardiologist 13 and the operator 12 are present in the same physical facility, along with the remote health care system 10. In some implementations, the operator 12, the cardiologist 13, and the remote health care system 10 are all in distinct physical locations. For example, the operator 12 may be in one country, the cardiologist 13 in another, and the remote health care system 10 in a third country, or distributed across various locations.

The patient's call is initially routed to an operator 12 who serves as an initial call screener. This operator 12 asks the patient 11 a set of initial questions. The answers the initial call screener receives from the patient 11 determines how the patient's call is subsequently routed, or if any additional procedures to be initiated. Generally, if the operator 12 determines that the patient 11 is experiencing symptoms potentially indicative of an adverse cardiac event, the operator 12 routes the patient's call to a cardiologist 13.

For example, a patient 11 calling with a routine or non-cardiac issue may not be transferred to consult a cardiologist 13. On the other hand, a patient 11 experiencing symptoms including (but not limited to) tightness in the chest, other chest discomfort, arm, neck, or jaw pain, or nausea may be transferred to consult a cardiologist 13.

The remote health care system 10 includes a communications module 14, a diagnostic module 16, a medical records module 18, an emergency services module 20, and a display 22. The remote health care system components 14-22 can be hardware, software, or a combination of hardware and software. For example, the remote health care system 10 can be implemented via one or more data storage devices (including magnetic storage such as a hard drive or random access memory (RAM), and optical storage such as a CD-ROM) in data communication with one or more microprocessors configured to execute instructions stored on the data storage. The remote health care system may include hardware that interfaces with a communications network, such as a local telephone system, a local area network (LAN), or a wide area network (WAN) such as the internet. In some implementations, different components 14-22 of the remote health care system 10 are implemented using distinct microprocessors and/or data storage devices. In such implementations, data may be routed between the components 14-22 over the communications network.

The communications module 14 routes communication (including data communication, voice communication, video communication, fax communication, or other communication) between and amongst the components 16-22 of the remote health care system 10, as well as other entities including a patient 11, one or more operators 12, the patient's primary care physician 24, one or more hospitals 26, and one or more emergency vehicle dispatch centers 28.

In some implementations, a patient 11 can access personal diagnostic equipment capable of transmitting data to a remote location. Such diagnostic equipment may include a portable EKG machine that is equipped to transmit its results over a communication channel such as a telephone connection. For example, the patient 11 may be in possession of a 12-lead EKG machine such as the HeartView P12/8, manufactured by Aerotel Medical Systems, headquartered at 5 Hazoref St., Holon 58856, Israel. The HeartView P12/8 is configured to perform an EKG test on a person, and transmit the results of the EKG test via an audio-encoded signal over a telephone line or other audio communication channel. As a second example, patient 11 may be in possession of a 12-lead EKG shirt or vest, where the shirt or vest includes electrodes and the ability to record a 12-lead EKG of the patient when worn and transmit the EKG results to the diagnostic module 16. Other EKG machines or diagnostic equipment configured to transmit test results using a different communication medium or mode could be also used.

Alternatively or in addition to having access to portable EKG machine, the patient 11 may also have access to blood testing equipment capable of transmitting blood test results to a remote location. In some implementations, the remote blood test equipment is configured to detect troponin levels or creatine kinase (CK) levels in the patient's blood.

In some cases, the cardiologist 13 may instruct the patient 11 to perform a diagnostic test using the patient's diagnostic equipment, and transmit the results to the remote health care system 10. The diagnostic module 16 is configured to decode the signal sent from the patient, and send a visual representation of the diagnostic test to the display 22. The operator 12 views the results of the diagnostic test, and proceeds accordingly (see FIG. 2).

In some implementations, for example when the diagnostic test include an EKG test, the cardiologist 13 compares the results of the current EKG test with one or more previous EKG tests. The diagnostic module 16 assists the cardiologist 13 in assessing the patient's health with analytical tools and the ability to compare the new EKG against various previous EKGs or a baseline EKG For example, these analytical tools may align the various EKG tests according to the operator's instructions (e.g., a lead-by-lead comparison, a combined comparison, etc.), or calculate characteristics of the EKGs (e.g., length of the QT interval, the PR interval, etc.)

In some implementations, for example when the diagnostic test includes a blood test, the cardiologist 13 compares the results of the current blood test with one or more previous blood tests. The diagnostic module 16 assists the cardiologist 13 in assessing the patient's health with analytical tools and the ability to compare the new blood test against a determined standard. For example, these analytical tools may: compute levels of various chemical species, including troponin and/or CK, in the blood; compute mathematical functions of such levels, including computing correlations among different chemical species; compare the current level of a chemical species such as troponin or CK to a pre-determined level, and compute a deviation from the pre-determined level.

In some cases, the operator 12 or cardiologist 13 is interested in the patient's previous medical records while the operator 12 or cardiologist 13 is assessing the patient's condition. The medical records module 18 stores the medical records of each patient 11 registered with the remote health care system 10, which can be transmitted to the operator 12 or cardiologist 13, and are displayable on display 22.

The display 22 may include a visual display such as a computer monitor, or an audio display such as a speaker system or a telephone. Although only one display 22 is shown in FIG. 1, in principle any number of displays 22 may be used.

When a patient 11 initially registers with the remote health care system 10, the patient 11 or the patient's personal physician 24 provides a current and complete medical history. Here, “complete” refers only to the patient's cardiac history. For example, if the patient 11 sprained an ankle while the patient 11 was an adolescent, this fact need not be included in the patient's medical history if it is not relevant to the patient's cardiac health. The medical history includes a description of all previous cardiac events, procedures, medications prescribed to the patient 11, and the results of all the patient's previous cardiac tests.

To help keep the medical records of the patient 11 updated, the remote health care system 10 will periodically query other entities who may have new medical data concerning a patient 11. These other entities include the patient's personal physician or physicians 24 (including, e.g., the patient's primary care physician, cardiologist, or any other specialists who care for the patient 11), any hospital 26 at which the patient has had a recent medical procedure performed, the patient 11 himself, and other sources or other medical specialists who care for the patient 11. In some implementations, the remote health care system 10 automatically contacts the patient 11 for a periodic request for an up-to-date EKG to help diagnose the patient 11 in the future. In some implementations, this periodic request is made monthly or bimonthly, although in principle any period of time could be used.

The availability of accurate and up-to-date medical records for the patient 11 helps the cardiologist 13 make an accurate diagnosis. For example, the patient 11 may experience symptoms that typically are not cause for concern. However, if recent medical records for the patient 11 indicate that those symptoms recently accompanied a foreboding EKG test result or a dangerous condition in the patient 11, the cardiologist 13 may interpret the recurrence of these symptoms differently than how he would have without the recent medical records.

To help maintain accurate and up-to-date medical records for the patient 11, periodically querying the patient's personal physicians 24 provides an advantage over only querying the patient 11. Some patients 11 are less likely to respond to these periodic queries than their personal physicians 24, because the patient 11 is too busy to respond during the time in which he receives the query, or another reason. Moreover, some patients 11 are less likely to fully and accurately respond to the query, because they do not have all the responsive documentation, or do not appreciate the relevance of certain facts. On the other hand, a personal physician 24 often maintains detailed records concerning the patient 11, and often employs a staff trained in the handling of such documentation.

In some cases, the operator 12 or cardiologist 13 may determine that the patient's condition requires immediate medical attention that is ideally provided in a hospital 26. When this determination is made, the operator 12 or cardiologist 13 arranges for an emergency vehicle (such as an ambulance) to transport the patient 11 to the hospital 26. The emergency services module 20 determines which emergency vehicle dispatch center 28 to contact, and which hospital to transport the patient 11 to. The term “emergency vehicle dispatch center” is meant to include any privately or governmentally operated emergency vehicle service, or any entity with authority to cause such a vehicle service to dispatch an emergency vehicle. In particular, the emergency vehicle dispatch center 28 can include a 9-1-1 call center.

In some implementations, the remote health care system 10 is operated twenty-four hours a day, seven days a week. To help maintain uninterrupted functionality, the remote health care system 10 may include duplicates (not shown) of any subset of components 14-22 and a fault detection module (not shown) configured to detect whether any component 14-22 is not properly functioning. In the event of a component malfunction or power loss, the fault detection module activates the corresponding duplicate component.

In FIG. 2, one use of the remote health care system 10 involves receiving a call from a patient 11 (step 30). The patient's call is initially screened to determine basic information such as the patient's symptoms (step 32). The initial screen is performed by an operator 12.

The operator 12 determines whether the patient 11 is in a clear emergency condition that warrants immediate action (step 34). If the patient 11 is in a clear emergency condition, the operator 12 initiates an emergency procedure (step 36), which is described more fully below (see FIG. 3) and connects the call to the cardiologist 13. If the patient 11 is not in a clear emergency condition, but exhibits symptoms that potentially indicate a cardiac event, the operator 12 routes the patient's call to a cardiologist 13. The cardiologist 13 performs a medical screen (step 38).

The medical screen (step 38) involves a cardiologist 13 asking the patient 11 questions about his current medical condition. In some implementations, the questions asked by the cardiologist 13 are dictated by a pre-determined protocol. For example, the cardiologist 13 can ask the patient 11 to describe the symptoms that prompted him to place the call to the remote health care system 10, or what activities the patient was undertaking prior to experiencing the symptoms. Based on the patient's input and the cardiologist's judgment, the cardiologist 13 decides whether a diagnostic test is warranted (step 40).

If a diagnostic test is warranted, the cardiologist 13 instructs the patient 11 to perform the diagnostic test using the patient's diagnostic equipment (step 42). When the patient 11 completes the diagnostic test, the test results are received (step 44) by the remote health care system 10. The results are decoded by the diagnostic module 16 and shown to the operator 12 on the display 22. The cardiologist 13 continues the medical screen (step 38) by examining the results of the diagnostic test, and possibly asking the patient 11 more questions.

Whether or not a diagnostic test is performed, the cardiologist 13 undertakes an analysis of the patient's medical condition. This analysis may be informed by the patient's answers to questions posed by an operator 12, the diagnostic test results produced in step 42, or comparison with patient's previous medical records. In some implementations, the analysis includes a comparison of an EKG test produced in step 42 with a previous EKG test described in the patient's medical records.

Eventually, the cardiologist 13 has asked a sufficient number of questions so as to make an evaluation of the patient's symptoms (step 46). The evaluation may be a specific diagnosis, an assessment of health, or a determination of a further course of action. For example, the evaluation may be that the patient 11 has suffered a heart attack, that patient 11 is suffering from heartburn, or that the patient's medical condition is nominal.

Based on the cardiologist's conclusion, the cardiologist 13 determines whether the patient 11 is in an emergency condition (step 48). If the patient 11 is in an emergency condition, the cardiologist initiates an emergency procedure (step 50), which is explained more fully below (see FIG. 3). If the patient 11 is not in an emergency condition, the cardiologist initiates a dialogue (step 52) with the patient 11 concerning the patient's symptoms, what future action to take (if any), and answers any questions the patient 11 may have. The patient's call to the remote health care system 10 is ended.

The patient's records are updated (step 54) by the remote health care system 10, the operator 12, the cardiologist 13, or any combination of these. The updated records may reflect new information (for example, the new EKG test that the patient 11 performed during the call), other health-related information, or non-health related information such as the duration and time of the call, which operators 12 or cardiologists 13 were involved, or other non-health related information. A report containing new information in the updated records is generated either by an operator 12, a cardiologist 13, the remote health care system 10, or a combination of these, and is sent to one or more of the patient's personal physicians 24.

Periodically, the remote health care system 10 or an operator 12 seeks monetary reimbursement for the services provided by the remote health care system 10 or its operators 12. The reimbursement may be sought directly from individual patients 11, or from third parties designated by the patients 11. For example, a third party may include a health insurance provider of a patient 11. Alternatively or in addition to seeking reimbursement, the remote health care system 10 may periodically prepare invoices to be distributed, the payment of which will entitle a patient 11 to use the remote health care system 10 for a period of time.

Because the remote health care system 10 and its use helps a patient 11 undergo treatment for an adverse cardiac event relatively quickly, some entities, e.g. insurance companies, hospitals, care facilities, or other entities, may wish to provide an incentive for patients 11 to use the remote health care system 10. One way to provide an incentive is by reducing fares (e.g., insurance rates, treatment costs such as surgery costs, medication costs, etc.) for certain services the entity provides, if the patient 11 is registered with the remote health care system 10. In some implementations, the entity establishes a distinct payment class that includes those who are enrolled in a program using the remote health care system 10. Members of this payment class may be charged less (or reimbursed more) for cardiac and cardiac-related care.

Referring to FIG. 3, an emergency procedure (steps 36, 50) is described. The steps described below need not take place in the order described. In particular, the steps can occur simultaneously, unless simultaneous execution is logically impossible. Furthermore, more than one operator 12 or cardiologist 13 may perform any subset of the actions described below. In some implementations, the operator 12 or cardiologist 13 who initiated the emergency procedure performs none of the tasks described below, but instead remains in communication with the patient 11 while other operators 12, other cardiologists 13, or the remote health care system 10 carry out the emergency procedure.

When an operator 12 initiates an emergency procedure, the patient's location is determined (step 56). When a patient 11 registers with the remote health care system 10, the patient provides the remote health care system 10 with several addresses at which the patient 11 is likely to be found. For example, the patient 11 may provide a home address, a work address, a family member's address, or any address at which the patient 11 is regularly present. During the initial screen (step 32, FIG. 2) the operator 12 may ask the patient 11 where he is. In some embodiments, the remote health care system 10 determines the patient's location based on a locator device (such as a GPS device) included in the patient's phone, the patient's diagnostic equipment, or otherwise in the patient's possession.

Based on the patient's location, the operator 12, cardiologist 13, or the remote health care system 10 determines a particular emergency vehicle dispatch center 28 to contact (step 58). In some implementations, the remote health care system 10 includes a list of emergency vehicle dispatch centers 28 including their direct phone numbers, and the corresponding geographic areas each emergency vehicle dispatch center 28 serves. An emergency vehicle dispatch center 28 is contacted by the operator 12 or the remote health care system 10 only if the emergency vehicle dispatch center 28 services the geographic area in which the patient 11 is located.

The operator 12, cardiologist 13, or the remote health care system 10 contacts (step 60) the emergency vehicle dispatch center 28 determined in step 58.

In the case where a 9-1-1 call center is contacted in step 60, a direct line of communication is used (as opposed to merely dialing “9-1-1” on a telephone.) Directly contacting the 9-1-1 call center that services the patient's geographic location increases the efficiency of the 9-1-1 call center in routing an emergency vehicle to the patient. Moreover, directly contacting this 9-1-1 call saves time by omitting any otherwise unnecessary telephone routing (as may occur if, for instance, the operator 12, cardiologist 13, or remote health care center 10 dialed 9-1-1 from its local telephone line.)

Based on the patient's systems or EKG test, the operator 12 determines a possible treatment of the patient 11 (step 62). The patient's possible course of treatment is based on the cardiologist's assessment of what treatment the patient 11 will likely require. For example, the cardiologist 13 may determine in step 46 (FIG. 2) that the patient 11 is experiencing a serious cardiac event such as a heart attack. Thus, the cardiologist 13 may determine that the patient's possible course of treatment includes surgery. Alternatively, if the cardiologist 13 determines in step 46 (FIG. 2) that the patient 11 exhibits symptoms indicative of a non-life-threatening cardiac event, the patient's possible course of treatment may include further tests.

In some geographic areas, some hospitals 26 are not equipped with sufficient technology, or staffed with sufficient personnel, to provide the possible course of treatment the cardiologist 13 determines may be necessary for the patient 11. For example, the cardiologist 13 may determine that the patient 11 is likely to require an angioplasty and stent procedure. If there are hospitals 26 that, despite being near the patient 11, are not equipped to perform this procedure, the emergency vehicle is instructed to avoid that hospital 26.

Thus, if necessary, the operator 12, the cardiologist 13, or the remote health care system 10 provides the emergency vehicle dispatch center 28 with special instructions concerning the possible course of treatment the patient 11 is to receive (step 64). These special instructions may include a particular hospital 26 to which the patient 11 should be transported, or a particular hospital 26 to which the patient 11 should not be transported. Additionally, the special instructions may include a particular course of treatment to be carried out en route to a hospital 26.

At any time during the performance of the steps described above, an operator 12 or the remote health care system 10 alerts the patient's personal physician 24 as to the medical status of the patient 11 (step 66). The alert may include the patient's EKG, a description of the patient's symptoms, the patient's current location, and the location of the hospital 26 to which the patient 11 is being transported.

Furthermore, an operator 12, cardiologist 13, or the remote health care system 10 alerts the hospital 26 to which the patient 11 is being transported that the patient is en route (step 68). Additionally, the operator 12, cardiologist 13, or the remote health care system 10 sends the results of any EKG or other diagnostic tests to the hospital 26, including comments of one or more operators 12 or cardiologists 13 (step 70).

When the patient 11 arrives at the hospital 26, the hospital personnel administers treatment to the patient 11, the treatment being informed by the information provided by the remote health care system 10, the operator 12, or the cardiologist 13. For example, the hospital personnel may administer a medication to the patient 11. In some implementations, the medication is one that affects the ability of the patient's blood to form or maintain a clot. For example, the medication may include a tissue plasminogen activator (tPA), uokinase, a low-molecular weight heparin such as enoxaparin or heparin. In some implementations, the treatment includes a diagnostic procedure, such as an angiogram. In some implementations, the treatment includes and interventional procedure such as an angioplasty or installing a stent. In some implementations, the treatment includes a surgical procedure, such as a cardiac bypass. In some implementations, the treatment is administered to the patient 11 by the hospital personnel within one, two, three, or four hours within the patient 11 initially contacting the remote health care system 10.

The remote health care system 10 and the procedures described above can help reduce the time between which a patient 11 first experiences symptoms indicative of a cardiac event and when the patient 11 is treated. In some implementations, this time interval is less than two hours. Because cardiac events typically do not occur at a predictable time, in some implementations the remote health care system 10 is staffed twenty-four hours a day, seven days a week with at least one operator 12 and cardiologist 13.

In FIG. 4, a quality control procedure 72 is employed to help the remote health care system 10 in meeting cardiac care quality expectations. When a cardiologist 13 evaluates a patient's medical condition (step 46, FIG. 2), the cardiologist's evaluation is recorded by the remote health care system 10 (step 74). If the patient 11 experiences an unexpected adverse cardiac event within a pre-determined time after being evaluated by the cardiologist 13, the cardiologist's evaluation of the patient 11 is reviewed by a reviewing body (step 76). Alternatively, a randomly-selected evaluation may also be reviewed by the reviewing body.

The members of the reviewing body may include another cardiologist 13 or a group of cardiologists 13. The reviewing body determines whether the cardiologist's evaluation comported with established protocols (step 78). If the evaluation did not comport with the established protocols, the cardiologist may face an appropriate penalty (step 80). In some implementations, the reviewing body adjusts the protocols over time to reflect their collective judgment of best practices. In some implementations, one or more members of the reviewing body are regarded as experts in an area of health care.

Other embodiments are within the scope of the following claims.

What is claimed is:

1. A remote health care system comprising:
a diagnostic receiver configured to receive a diagnostic test from a patient;
a medical records module in data communication with the diagnostic receiver, the medical records module including a medical record of the patient; and
an emergency services module in data communication with the diagnostic receiver, the emergency services module including a description of a geographic location and an emergency vehicle dispatch center corresponding to the location.

2. The remote health care system of claim 1 further comprising a fault detection module configured to:
detect a malfunctioning component of the remote health care system and;
activate a duplicate component of the health care system.

3. The remote health care system of claim 1 further comprising a communications module in data communication with the emergency services module, the communications module configured to cause the emergency vehicle dispatch center to dispatch an emergency vehicle to the patient.

4. The remote health care system of claim 1 further comprising a communications module in data communication with the medical records module, the communications module configured to transmit the medical record to a treatment facility.

5. The remote health care system of claim 1 further comprising a communications module in data communication with the medical records module, the communications module configured to transmit a cardiac evaluation of the patient to a personal physician of the patient.

6. The remote health care system of claim 1, further comprising a communications module in data communication with the medical records module, the communications module configured to allow a cardiologist to access the diagnostic test.

7. The remote health care system of claim 1 further comprising a communications module in data communication with the medical records module, the communications module configured to allow a cardiologist to access a medical history of the patient.

8. The remote health care system of 7, in which the medical record includes a prior EKG test of the patient.

9. The remote health care system of claim 1 wherein the diagnostic receiver includes an EKG module, and the diagnostic test includes an EKG test.

10. The remote health care system of claim 9, wherein the EKG test includes a 12-lead EKG test.

11. The remote health care system of claim 9 wherein the EKG module is configured to compare the EKG test to a previously recorded EKG.

12. A method comprising:
receiving a medical record for a patient;
subsequently receiving a description of symptoms from the patient, the symptoms describing a current medical state of the patient;
transmitting a description of the symptoms to a cardiologist,
receiving a diagnostic test from the patient; and
transmitting the results of the diagnostic test to the cardiologist.

13. The method of claim 12, in which the diagnostic test includes an EKG test.

14. The method of claim 13 in which the diagnostic test includes a blood test.

15. The method of claim 12 in which the medical record includes a description of a medical history including a description of at least one cardiac test result.

16. The method of claim 15 in which the medical record includes a complete medical history of the patient.

17. The method of claim 15 further comprising transmitting a portion of the medical history to the cardiologist.

18. The method of claim 12 further comprising determining a location of the patient.

19. The method of claim 18 further comprising determining an emergency vehicle dispatch center based on the location of the patient.

20. The method of claim 19 further comprising causing the emergency vehicle dispatch center to dispatch an emergency vehicle to the location of the patient.

21. The method of claim 20 further comprising determining a probable course of treatment for the patient.

22. The method of claim 21 in which the probable course of treatment is determined by the cardiologist based on at least one of: the diagnostic test, the symptoms, and the medical record of the patient.

23. The method of 22 in which the probable course of treatment is determined to mitigate an adverse cardiac condition of the patient.

24. The method of claim 21 further comprising determining a treatment facility based on the probable course of treatment.

25. The method of claim 24 further comprising causing the emergency vehicle dispatch center to dispatch an emergency vehicle to the location of the patient and transport the patient to the treatment facility.

26. The method of claim 12 further comprising querying a personal physician of the patient for an updated medical record for the patient.

27. The method of claim 12 further comprising querying the patient for an updated diagnostic test.

28. The method of claim 27 wherein the diagnostic test is an EKG test.

29. The method of claim 27 wherein the diagnostic test is a blood test.

30. The method of claim 12 further comprising seeking reimbursement for a provided service.

31. The method of claim 30 in which the reimbursement is sought from an insurer of the patient.

32. The method of claim 12, wherein the patient is located in a first country and one of the cardiologist or an operator is located in a second country.

33. The method of claim 32, wherein the patient is located in a first country and the cardiologist is located in a second country and the operator is in a third country.

34. The method of claim 12, further comprising receiving information about the medical condition of the patient from the cardiologist, and transmitting the information to a health care provider.

35. The method of claim 12 further comprising:
recording an evaluation of the current medical state of the patient by the cardiologist;
displaying the evaluation to a quality-control cardiologist; and
receiving a quality review of the evaluation from the quality-control cardiologist.

36. A method of treating a patient for a cardiac disorder comprising:
receiving diagnostic information describing a current cardiac condition of a patient from a remote source;
in response to said information, scheduling a service for the patient.

37. The method of claim 36, in which the service includes administering medication to the patient.

38. The method of claim 37, in which the medication includes a component selected from the group consisting of: tPA, uokinase, enoxaparin, and heparin.

39. The method of claim 36, in which the service includes performing a surgical procedure.

40. The method of claim 39, in which the surgical procedure is selected from the group consisting of: performing bypass surgery, performing an angioplasty, and installing a stent.

41. The method of claim 36, wherein the service is performed within 4 hours of receiving information from the remote source.

42. A method of dispatching an emergency vehicle comprising:
receiving instructions from a system described in claim 1 about a patient, the instructions including a geographic location of the patient, a destination care facility for the patient, and a medical condition of the patient;
dispatching an emergency vehicle to said patient.

43. The method of claim 42, in which the instructions also include a recommended course of medical care for the patient while the patient is in transit to the destination care facility.

44. A method of discounting treatment for a cardiac patient, the method comprising:
receiving information from a remote health care system about a medical condition of the cardiac subject, the information being received prior to an arrival of the cardiac subject;
based on the information, preparing a treatment, the preparing taking place prior to the arrival of the cardiac subject;
administering the treatment for the cardiac subject after the arrival of the cardiac subject;
based on having received the information from the remote health care system, producing a bill for the treatment at a discounted rate, the discounted rate being less than a standard rate the treatment would cost a general cardiac subject having a medical condition equivalent to the medical condition of the cardiac subject.

45. The method of claim 44, in which the treatment includes a medication.

46. The method of claim 44, in which the treatment includes a surgical procedure.

47. A method of providing insurance benefits for a cardiac patient, the method comprising:
determining that the cardiac patient is enrolled with a remote health care facility, the remote health care facility being capable of:
receiving a medical record for the cardiac patient;
subsequently receiving a description of symptoms from the cardiac patient, the symptoms describing a current medical state of the cardiac patient;
transmitting a description of the symptoms to a cardiologist, receiving a diagnostic test from the patient; and
transmitting the results of the diagnostic test to the cardiologist;
providing the insurance benefit, based on the cardiac patient being enrolled with the remote health care facility.

48. The method of claim 47, wherein the insurance benefit includes providing a first level of reimbursement for the treatment to the cardiac patient, in which a different, second level of reimbursement for the treatment is provided to a second patient who is not enrolled with the remote health care facility.

49. The method of claim 48, in which the insurance benefit includes a reduced premium of an insurance policy on the cardiac patient.
